(19) United States
(12) Patent Application Publication
(10) Pub. No.: US 2019/0258133 A1
(43) Pub. Date: Aug. 22, 2019

(54) METHOD AND APPARATUS FOR DRIVING LIQUID CRYSTAL LENS

(71) Applicants: SAMSUNG ELECTRONICS CO., LTD., Suwon-si (KR); KYUNGPOOK NATIONAL UNIVERSITY INDUSTRY - ACADEMIC COOPERATION FOUNDATION, Daegu (KR)

(72) Inventors: Chiyul YOON, Suwon-si (KR); Jonghoo PARK, Daegu (KR)

(73) Assignees: SAMSUNG ELECTRONICS CO., LTD., Suwon-si (KR); KYUNGPOOK NATIONAL UNIVERSITY INDUSTRY - ACADEMIC COOPERATION FOUNDATION, Daegu (KR)

(21) Appl. No.: 16/281,302

(22) Filed: Feb. 21, 2019

(30) Foreign Application Priority Data
Feb. 21, 2018 (KR) 10-2018-0020675

(51) Int. Cl. G02F 1/29

(52) U.S. Cl. CPC G02F 1/29

(57) ABSTRACT

Provided are a method of and an apparatus for driving a liquid crystal lens. The apparatus includes a first substrate and a second substrate which face each other; an electrode on the first substrate, the electrode including plural areas that are spaced apart from each other; a common ground electrode on the second substrate; a liquid crystal layer injected between the first substrate and the second substrate and including liquid crystal molecules; a voltage source that respectively applies separate voltages to the plural areas according to a voltage profile after a threshold voltage is applied to the plural areas; and a processor that controls a voltage applied by the voltage source to the plural areas.

### CROSS-REFERENCE TO RELATED APPLICATION(S)

This application is based on and claims priority under 35 U.S.C. § 119 to Korean Patent Application No. 10-2018-0020675, filed on Feb. 21, 2018, in the Korean Intellectual Property Office, the disclosure of which is incorporated by reference herein in its entirety.

### BACKGROUND

### 1. Field

The disclosure relates to methods and apparatuses for driving liquid crystal lenses, and a recording medium having recorded thereon a program for executing the methods.

### 2. Description of Related Art

Recently, development in optical display technology for modulating optical characteristics has been actively pursued. In particular, optical display technologies through which augmented reality (AR) images, virtual reality (VR) images, and the like may be displayed have drawn attention, and among such technologies, there has been an increasing interest in optical modulation technology for separating and transmitting images at different points in time to adjust focal lengths of output images so that viewers may enjoy the images more vividly.

Through the optical modulation technology, an optical path for constructing images may be changed to make images recognizable at desired locations. Examples of the optical modulation technology include a method of changing focal lengths of liquid crystal lenses, and the like. Examples of a method of changing focal lengths include a method of applying a voltage to an electrode having a frenel zone pattern and changing an orientation of liquid crystal molecules forming a liquid crystal lens.

### SUMMARY

Provided are a method and an apparatus for driving a liquid crystal lens for preventing a drastic change in a refractive index which is caused due to a gap area between areas when a voltage is applied to a liquid crystal layer of the liquid crystal lens by using an electrode including areas that are spaced apart from each other.

Additional aspects will be set forth in part in the description which follows and, in part, will be apparent from the description, or may be learned by practice of the presented embodiments.

According to an embodiment of the disclosure, an apparatus for driving a liquid crystal lens includes a first substrate and a second substrate which face each other; an electrode on the first substrate, the electrode comprising a plurality of areas that are spaced apart from each other; a common ground electrode on the second substrate; a liquid crystal layer injected between the first substrate and the second substrate and comprising a plurality of liquid crystal molecules; a voltage source configured to respectively apply separate voltages to the plurality of areas according to a voltage profile after a threshold voltage is applied to the plurality of areas; and a processor configured to control a voltage applied by the voltage source to the plurality of areas.

According to another embodiment of the disclosure, a method of driving a liquid crystal lens includes obtaining information regarding a threshold voltage and a voltage profile which is used to adjust a refractive index of a liquid crystal layer including a plurality of liquid crystal molecules injected between a first substrate and a second substrate; applying the threshold voltage to a plurality of areas of the first substrate from among the first substrate, on which an electrode comprising the plurality of areas that are spaced apart from each other is formed, and the second substrate on which a common ground electrode is formed; and respectively applying separate voltages to the plurality of areas according to the voltage profile.

### BRIEF DESCRIPTION OF THE DRAWING

The above and other aspects, features, and advantages of certain embodiments of the present disclosure will be more apparent from the following description taken in conjunction with the accompanying drawings, in which:

FIG. 1 is a diagram for explaining a method of determining a focal length of a liquid crystal lens by applying a separate voltage to an electrode having a pattern;

FIG. 2 is a block diagram for explaining an apparatus for driving a liquid crystal lens, according to an embodiment;

FIG. 3 is a diagram for explaining a drastic change in a refractive index, which is caused due to a gap area between electrodes;

FIG. 4 is a diagram for explaining a voltage that an apparatus for driving a liquid crystal lens applies to an electrode, according to an embodiment;

FIG. 5 is a graph for explaining a change in a gradient of liquid crystal molecules when a threshold voltage is applied, according to an embodiment;

FIG. 6 is a diagram for explaining a change in liquid crystal molecules when an apparatus for driving a liquid crystal lens applies a separate voltage after applying a threshold voltage, according to an embodiment;

FIG. 7 is a diagram for explaining a voltage that an apparatus for driving a liquid crystal lens applies to an electrode, according to an embodiment; and

FIG. 8 is a flowchart for explaining a method of driving a liquid crystal lens, according to an embodiment.

### DETAILED DESCRIPTION

Terms used in the present specification will be briefly described, and one or more embodiments will be described.

The terms used in this specification are those general terms currently widely used in the art in consideration of functions regarding the disclosure, but the terms may vary according to the intention of those of ordinary skill in the art, precedents, or new technology in the art. Also, specified terms may be selected by the applicant, and in this case, the detailed meaning thereof will be described in the detailed description. Thus, the terms used in the specification should be understood not as simple names but based on the meaning of the terms and the overall description of the disclosure.

It will be understood that although the terms “first”, “second”, etc. may be used herein to describe various components, these components should not be limited by these terms. These components are only used to distinguish one component from another. Thus, a first element discussed below may be termed a second element, and similarly, a second element may be termed a first element without departing from the teachings of this disclosure. As used herein, the term “and/or” includes any and all combinations of one or more of the associated listed items.

It will be further understood that the terms “comprises” and/or “comprising” used herein specify the presence of stated features or components, but do not preclude the presence or addition of one or more other features or components. Also, the term “unit” indicates a software component or a hardware component such as FPGA or ASIC and performs certain functions. However, units are not limited to software or hardware. “Units” may be included in storage media capable of performing addressing or may be configured to execute one or more processors. For example, “units” include components such as software components, object-oriented software components, class components, and task components, processes, functions, attributes, procedures, sub-routines, segments of program codes, drivers, firmware, micro-codes, circuits, data, database, data structures, tables, arrays, and variables. Components and functions provided by “units” may be integrated into a smaller number of components or and “units” or may be divided into additional components and “units”.

Reference will now be made in detail to embodiments, examples of which are illustrated in the accompanying drawings, wherein like reference numerals refer to like elements throughout. In this regard, the embodiments may have different forms and should not be construed as being limited to the descriptions set forth herein. Accordingly, the embodiments are merely described below, by referring to the figures, to explain aspects. For clarity of explanations, portions that are irrelevant to the description of the disclosure are omitted from the attached drawings, and like reference numerals denote like elements throughout the specification.

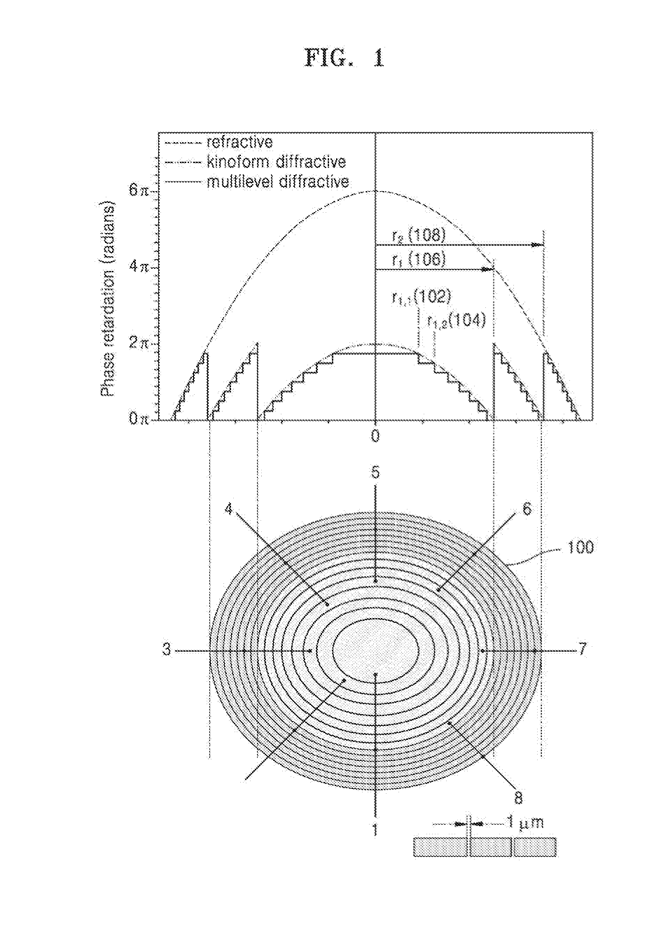

FIG. 1 is a diagram for explaining a method of determining a focal length of a liquid crystal lens by applying a separate voltage to an electrode having a pattern.

FIG. 1 shows an electrode 100 having the pattern. Here, the electrode 100 having the pattern may be a transparent electrode having a frenel zone pattern. However, this is merely an example, and one or more embodiments are not limited thereto.

An apparatus for driving a liquid crystal lens may use the electrode 100 having the pattern to change an orientation of liquid crystal molecules that form a liquid crystal layer of the liquid crystal lens. Here, it is assumed that the liquid crystal layer is injected between a first substrate, on which the electrode 100 having the pattern is formed, and a second substrate on which a common ground electrode is formed. In detail, the apparatus may apply a separate voltage to each area forming the pattern of the electrode 100. The orientation of the liquid crystal molecules may change according to an applied electric field, and based on the orientation, a refractive index may be determined. Therefore, according to the separate voltage applied to each area forming the pattern of the electrode 100, the orientation of liquid crystal molecules corresponding to each area may change.

The apparatus may change the orientation of the liquid crystal molecules of the liquid crystal layer for each area forming the pattern by using the electrode 100 having the pattern and may change a phase of light to make light passing through the liquid crystal lens cause constructive interference at the focal length. Referring to the graph of FIG. 1 which indicates a phase difference according to a radius of the electrode, it is found that the phases of light passing through the liquid crystal lens are different according to radiuses 102, 104, 106, and 108 within the electrode.

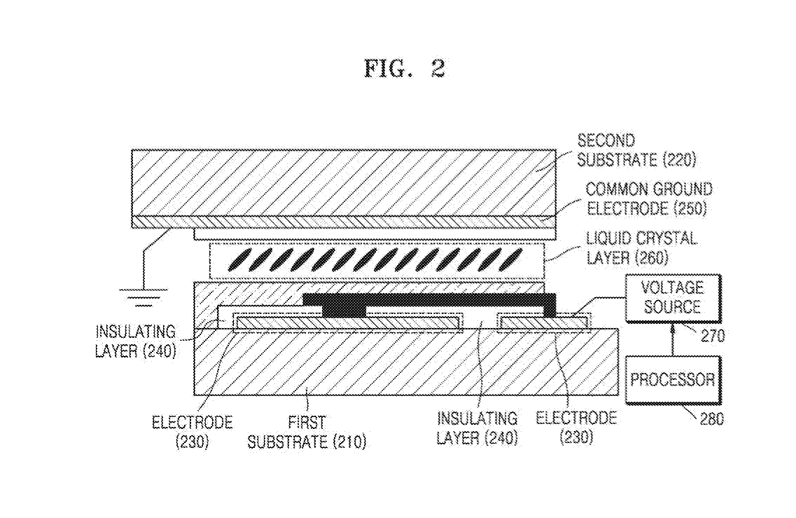

The liquid crystal molecules corresponding to the gap area between areas forming the pattern of the electrode 100 have a distorted orientation compared to liquid crystal molecules corresponding to other areas, and thus, a refractive index may dramatically change. In the present specification, the term “orientation” may have the same meaning as the gradient of the liquid crystal molecules. Accordingly, the apparatus according to an embodiment may apply a separate voltage to each area after applying the same threshold voltage to respective areas forming the pattern, and thus may prevent the distortion of the orientation of the liquid crystal molecules corresponding to the gap area by using continuous characteristics of the liquid crystal molecules, which will be described below in detail with reference to FIGS. 2 to 8.

The apparatus may be embodied in various forms. For example, the apparatus may be smart glasses, a head-mounted display (HMD), a near-eye display, a three-dimensional (3D) display, or the like. However, the apparatus is not limited thereto.

FIG. 2 is a block diagram for explaining an apparatus for driving a liquid crystal lens, according to an embodiment.

Referring to FIG. 2, an apparatus 200 may include a first substrate 210, a second substrate 220, an electrode 230 including areas, insulating layers 240, a common ground electrode 250, a liquid crystal layer 260, a voltage source 270, and a processor 280. However, this is merely an example, and components of the apparatus 200 are not limited thereto.

The first substrate 210 may face the second substrate 220. Also, the first substrate 210 and the second substrate 220 may each include a transparent material.

On the first substrate 210, there may be formed the electrode 230 including areas that are spaced apart from each other. The areas may be spaced apart by the insulating layers 240. In some embodiments, the electrode 230 may be separated into multiple areas by the insulating layers 240.

For example, the electrode 230 of the first substrate 210 may include M frenel areas according to a diameter and power of the lens, and each frenel area may include N sub-areas (a number of phase levels) where voltages may be separately applied. Accordingly, the electrode 230 may include M N rings in total, and the rings may be spaced apart from one another at intervals of 1 μm to several μm. An external diameter rₘⁿ of n^{th} sub-area (n=1, 2, 3, . . . , N) of m^{th} frenel area (m=1, 2, 3, . . . , M) may be determined based on the following Equation.

$${r}_{m}^{n} = \sqrt{2 \{ ( m - 1 ) + \frac{n}{N} \} λ f} \qquad [ Equation ]$$

where, λ indicates a wavelength, and f indicates a focal length. As identified based on the above Equation, a width of a ring may decrease as the number of phase levels increases, and as a diameter of the lens increases, a width of an outermost electrode may decrease. The processor 280 (described in more detail later) may apply a voltage to the electrode 230 by using the voltage source 270 and control the light passing through the liquid crystal layer to have a phase change of 0 to 2π.

Also, the common ground electrode 250 may be formed on the second substrate 220. The electrode 230 formed on the first substrate 210 and the common ground electrode 250 formed on the second substrate 220 may each have a transparent material.

The liquid crystal layer 260 may include liquid crystal molecules. Also, the liquid crystal layer 260 may be injected between the first substrate 210 and the second substrate 220. The orientation of the liquid crystal molecules forming the liquid crystal layer 260 may be determined according to a voltage applied to the electrode 230 of the first substrate 210.

The voltage source 270 may respectively apply voltages to the areas forming the electrode 230 of the first substrate 210. In this case, the voltages applied to the areas through the voltage source 270 may be determined by the processor 280.

The processor 280 may apply a common threshold voltage to each area forming the electrode 230 of the first substrate 210. Also, after applying the threshold voltage, the processor 280 may apply a separate voltage to each area according to a voltage profile that is previously set. Before applying the separate voltage, the processor 280 may change the orientation of the liquid crystal molecules by applying the threshold voltage and may minimize the distortion of the orientation of the liquid crystal molecules in the gap area during the application of the separate voltage.

The threshold voltage may be a voltage that makes the liquid crystal molecules have a maximum value of a gradient that is parallel to a direction of the applied electric field. Also, the threshold voltage may be an alternating current (AC) voltage and a direct current (DC) voltage.

The processor 280 may set a period of time, during which the threshold voltages are applied to the areas forming the electrode, to be equal to or greater than a reaction time of the liquid crystal molecules. Also, the processor 280 may set a value of the threshold voltage to make the gradient of the liquid crystal molecules corresponding to the gap area be within a preset range.

For example, when a gradient is Ga when a voltage V1 is applied to a first area, and when a gradient is Gb when a voltage V2 is applied to a second area, the processor 280 may set a value of the threshold voltage to ensure that the gradient of the liquid crystal molecules corresponding to the gap has a value between Ga and Gb. However, this is merely an example, and the value of the threshold voltage set by the processor 280 is not limited thereto.

A memory (not shown) of the apparatus 200 may store therein a database in which values of the threshold voltage, which are experimentally determined according to voltage profiles of the liquid crystal layer 260, are classified. Here, the voltage profiles of the liquid crystal layer 260 may differ according to types of liquid crystal molecules and a desired refractive index. The processor 280 may select a value of the threshold voltage corresponding to a voltage profile regarding the liquid crystal layer 260 from among values of the threshold voltage which are stored in advance in the database.

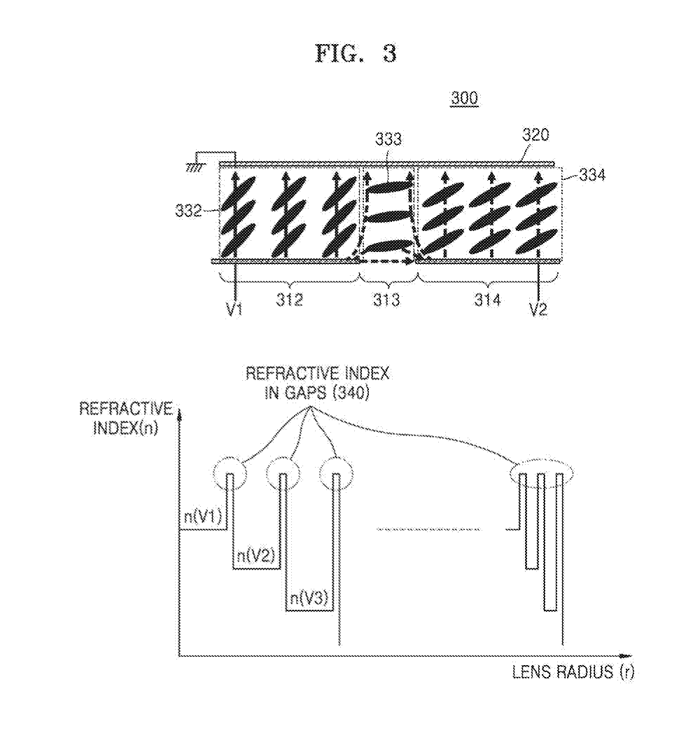

FIG. 3 is a diagram for explaining a drastic change in a refractive index, which is caused due to a gap area between electrodes.

FIG. 3 shows an electrode 300 including a first area 312 and a second area 314 and a common ground electrode 320. There may be at least two areas forming the electrode 300, but in the example shown in FIG. 3, it is assumed that the electrode 300 includes two areas, that is, the first area 312 and the second area 314, for convenience of explanation.

By using a voltage source (not shown in FIG. 3), a processor (not shown in FIG. 3) may apply voltages V1 and V2 to the first area 312 and the second area 314, respectively. Accordingly, in a liquid crystal layer, an orientation of first liquid crystal molecules 332 corresponding to the first area 312 may be changed to the gradient Ga that corresponds to the voltage V1. Also, in the liquid crystal layer, an orientation of second liquid crystal molecules 334 corresponding to the second area 314 may be changed to the gradient Gb that corresponds to the voltage V2.

An orientation of liquid crystal molecules 333 that corresponds to a gap area 313 between the first area 312 and the second area 314 is rarely affected by the voltages V1 and V2, and thus the orientation of liquid crystal molecules 333 may be greatly different from the orientations of the first liquid crystal molecules 332 and the second liquid crystal molecules 334. Accordingly, a refractive index of the liquid crystal molecules 333 corresponding to the gap area 313 may greatly change, and thus the diffraction efficiency may decrease.

The graph at the bottom of FIG. 3 shows a change in a refractive index n according to a lens radius r. Here, areas forming an electrode may be divided according to the lens radius r. In the graph of FIG. 3, for example, n(V1) indicates a refractive index of liquid crystal molecules corresponding to an area where the voltage V1 is applied, and n(V2) indicates a refractive index of liquid crystal molecules corresponding to an area where the voltage V2 is applied. It is identified that the refractive index sharply changes in the gap area between the areas where the voltage V1 and the voltage V2 are respectively applied.

The apparatus according to an embodiment may apply the threshold voltage before separately applying the voltages to the areas forming the electrode and thus may prevent a refractive index 340 of the liquid crystal molecules corresponding to the gap area 313 from drastically changing.

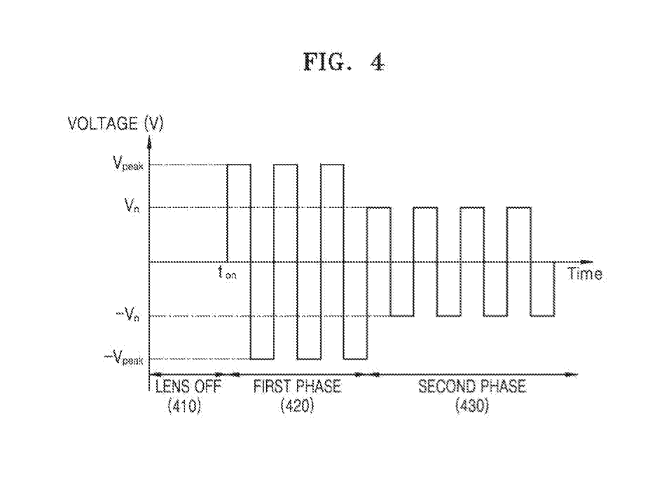

FIG. 4 is a diagram for explaining a voltage that an apparatus for driving a liquid crystal lens applies to an electrode, according to an embodiment.

Referring to FIG. 4, when the apparatus turns on the liquid crystal lens after an operation 410 of turning off the liquid crystal lens is terminated, the apparatus may apply a voltage in a first operation 420 and a second operation 430. In first operation 420, a voltage of square waves having the same peak value ±Vₚₑₐₖ may be applied to areas forming the electrode and being apart from each other. In the present specification, ±Vₚₑₐₖ may be the threshold voltage according to the one or more embodiments. Also, by considering a reaction time of liquid crystal molecules forming a liquid crystal layer, the apparatus may apply the threshold voltage for a period of time equal to or greater than the reaction time.

In second operation 430, the apparatus may respectively apply, to the areas forming the electrode, the separate voltages according to voltage profiles. Here, the separate voltages may differ in respective areas, but in the graph of FIG. 4, the separate voltages are indicated as +/−Vₙ for convenience of explanation.

After applying the voltage of square waves having the same peak value ±Vₚₑₐₖ to the areas, the apparatus may respectively apply the separate voltages to the areas and thus may prevent a great change in the refractive index of the liquid crystal layer corresponding to the gap area, based on continuous characteristics of the liquid crystal molecules forming the liquid crystal layer.

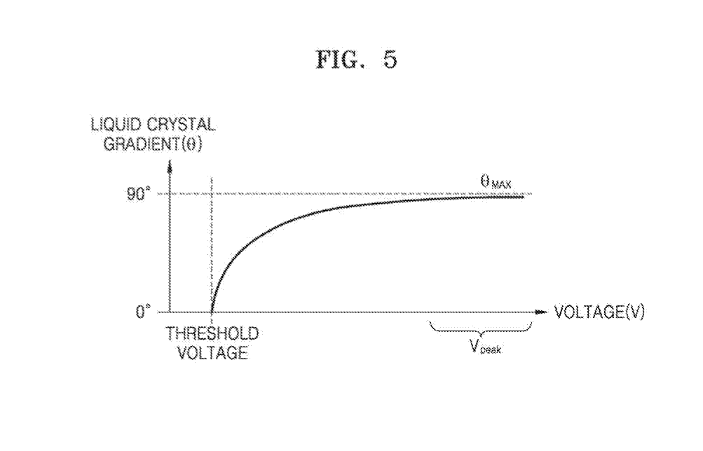

FIG. 5 is a graph for explaining a change in a gradient of liquid crystal molecules when a threshold voltage is applied, according to an embodiment.

Referring to FIG. 5, when the apparatus applies a threshold voltage Vₚₑₐₖ to the areas forming the electrode, it is found that the gradient of the liquid crystal molecules is changed to θ_{MAX} that is close to 90 degrees. By taking characteristics of the liquid crystal molecules forming the liquid crystal layer into account, the apparatus may obtain in advance information regarding the threshold voltage Vₚₑₐₖ by which the gradient of the liquid crystal molecules is changed to θ_{MAX}.

However, this is merely an example. The value of the threshold voltage is not limited to a value that makes the gradient of the liquid crystal molecules be close to 90 degrees. The apparatus may determine the value of the threshold voltage by considering the separate voltages to be applied after the threshold voltage is applied. That is, the gradient of 90 degrees is only an example, and the value of the threshold voltage may be a value that makes the gradient of the liquid crystal molecules be close to 180 degrees, 270 degrees, or some other gradient.

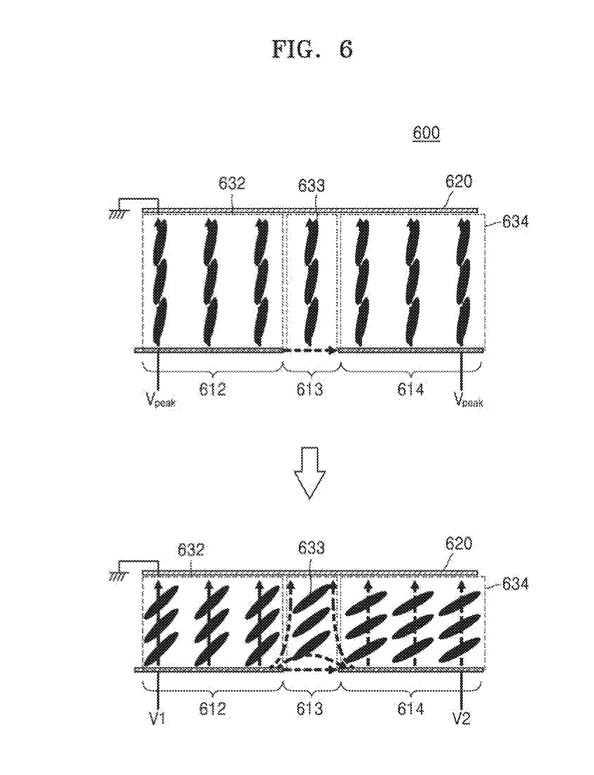

FIG. 6 is a diagram for explaining a change in liquid crystal molecules when an apparatus for driving a liquid crystal lens applies a separate voltage after applying a threshold voltage, according to an embodiment.

FIG. 6 shows an electrode 600 forming a first area 612 and a second area 614 and a common ground electrode 620. There may be at least two areas forming the electrode 600, but in the example shown in FIG. 6, the electrode includes two areas, that is, the first area 612 and the second area 614 for convenience of explanation.

By using a voltage source (not shown in FIG. 6), a processor (not shown in FIG. 6) may apply the threshold voltage Vₚₑₐₖ to each of the first area 612 and the second area 614. As the threshold voltage Vₚₑₐₖ is applied to the first area 612 and the second area 614, a gradient of first liquid crystal molecules 632 corresponding to the first area 612 and a gradient of second liquid crystal molecules 634 corresponding to the second area 614 may be changed to θ_{MAX}. A gradient of liquid crystal molecules 633 corresponding to a gap area 613 between the first area 612 and the second area 614 may also be changed to be close to θ_{MAX}.

After applying the threshold voltage Vₚₑₐₖ, the processor (not shown in FIG. 6) may respectively apply separate voltages V1 and V2 to the first area 612 and the second area 614, as shown in the bottom half of FIG. 6. Accordingly, in the liquid crystal layer, the orientation of the first liquid crystal molecules 632 corresponding to the first area 612 may be changed to a gradient Ga corresponding to the voltage V1. Also, in the liquid crystal layer, the orientation of the second liquid crystal molecules 634 corresponding to the second area 614 may be changed to a gradient Gb corresponding to the voltage V2.

When the separate voltages are respectively applied to the first area 612 and the second area 614 in a state in which the liquid crystal molecules 633 corresponding to the gap area 613 between the first area 612 and the second area 614 have the gradient according to the threshold voltage that is applied, the liquid crystal molecules 633 may have a gradient within a certain range between the gradients Ga and Gb due to the continuous characteristics of the liquid crystal molecules 633.

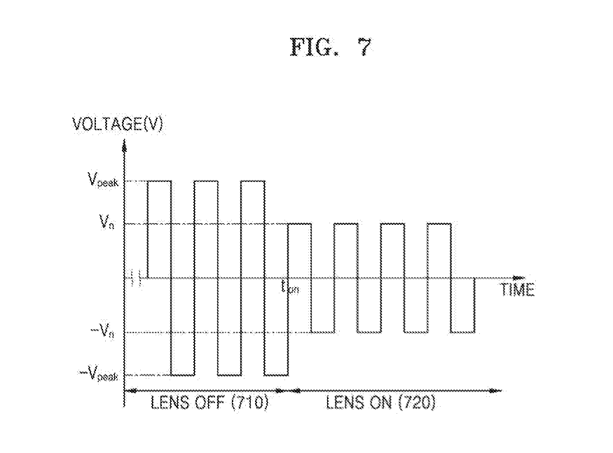

FIG. 7 is a diagram for explaining a voltage that an apparatus for driving a liquid crystal lens applies to an electrode, according to another embodiment.

Referring to FIG. 7, in operation 710 in which the liquid crystal lens is OFF, the apparatus may apply a voltage of square waves having the same peak value ±Vₚₑₐₖ to areas forming an electrode and being apart from each other. In the embodiment of FIG. 7, the peak value ±Vₚₑₐₖ may be the threshold voltage according to the embodiments discussed above. Also, by considering reaction times of liquid crystal molecules forming a liquid crystal layer, the apparatus may apply a threshold voltage for a period of time equal to or greater than the reaction times of the liquid crystal molecules.

Also, in operation 720 in which the liquid crystal lens is ON, the apparatus may respectively apply separate voltages to areas forming the electrode. Here, the separate voltages may differ according to the areas, but for convenience of explanation, in the graph of FIG. 7, the separate voltages are indicated as +/−Vₙ.

As the apparatus applies the separate voltages to the areas after a voltage of square waves having the same peak value ±Vₚₑₐₖ is applied to the areas, the apparatus may prevent a refractive index of the liquid crystal layer corresponding to a gap area from greatly changing, based on continuous characteristics of the liquid crystal molecules forming the liquid crystal layer.

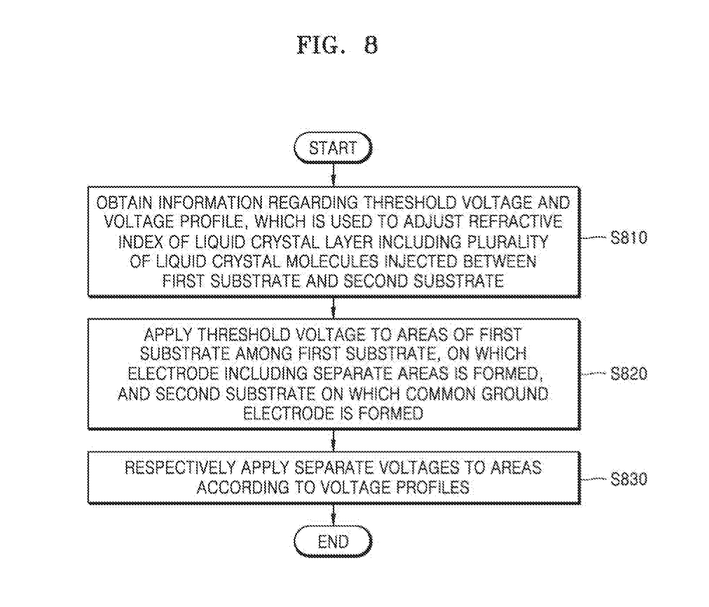

FIG. 8 is a flowchart for explaining a method of driving a liquid crystal lens, according to an embodiment.

In operation S810, the apparatus may obtain information regarding a threshold voltage and a voltage profile which is used to adjust a refractive index of a liquid crystal layer including liquid crystal molecules injected between a first substrate and a second substrate. The threshold voltage may be a voltage that makes the liquid crystal molecules have a maximum value of a gradient parallel to a direction of an applied electric field. However, this is merely an example, and the threshold voltage may have a value that allows the gradient of the liquid crystal molecules corresponding to the gap area between the areas to be within a preset range when the separate voltages are applied later.

In operation S820, the apparatus may apply the threshold voltage to electrodes formed on the first substrate among the first substrate, on which the electrodes including areas, which are spaced apart from each other, are formed, and the second substrate on which a common ground electrode is formed.

The apparatus may set a period of time, during which the threshold voltage is applied to the areas, to be equal to or greater than a reaction time of the liquid crystal molecules.

In operation S830, the apparatus may respectively apply separate voltages to the areas according to voltage profiles. Here, the voltage profiles may differ according to characteristics of the liquid crystal molecules forming the liquid crystal layer and a desired refractive index.

The method according to the one or more embodiments described above may be implemented as program commands executable by a processor and recorded in a non-transitory computer-readable recording medium. The non-transitory computer-readable recording medium may include program commands, data files, data structures, or any combination thereof. The program commands recorded in the non-transitory computer-readable recording medium may be specially designed for the disclosure. Examples of the non-transitory computer-readable recording medium include magnetic storage media (e.g., hard disks, floppy disks, magnetic tapes, etc.), optical media (e.g., CD-ROMs, DVDs, etc.), magneto-optical media (e.g., floptical disks, etc.), and hardware devices (e.g., ROM, RAM, flash memory, etc.) that are specially configured to store program commands that may be executed by a processor. Examples of the program commands include machine-language codes produced by compliers as well as high-level language codes executable by computers by using interpreters, and the like.

To promote understanding of one or more embodiments of the disclosure, reference has been made to the exemplary embodiments illustrated in the drawings, and specific language has been used to describe these embodiments. However, no limitation of the scope of the disclosure is intended by this specific language, and embodiments of the disclosure should be construed to encompass all embodiments which would normally occur to one of ordinary skill in the art.

The disclosure may be described in terms of functional block components and various processing steps. Such functional blocks may be realized by any number of hardware and/or software components configured to perform the specified functions. For example, the disclosure may employ various integrated circuit (IC) components, e.g., memory elements, processing elements, logic elements, look-up tables, and the like, which may carry out a variety of functions under the control of one or more microprocessors or other control devices. Also, the disclosure may employ different types of cores, central processing units (CPUs), or the like. Similarly, where the elements of the disclosure are implemented using software programming or software elements, the software may be implemented with any programming or scripting language such as C, C++, Java, assembler language, or the like, with the various algorithms being implemented with any combination of data structures, objects, processes, routines or other programming elements. Functional aspects may be implemented in algorithms that are executed by one or more processors. Furthermore, the embodiments may employ any number of techniques for electronics configuration, signal processing and/or control, data processing and the like. The words “mechanism”, “element”, “means”, and “configuration” are used broadly and are not limited to mechanical or physical embodiments, but may include software routines in conjunction with processors, etc.

The particular implementations shown and described herein are illustrative examples and are not intended to otherwise limit the scope of the disclosure in any way. For the sake of brevity, electronics, control systems, software development and other functional aspects of the systems may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the disclosure unless the element is specifically described as “essential” or “critical”.

The use of the terms “a” and “an” and “the” and similar referents in the specification (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Also, the steps of all methods described herein may be performed in any suitable order unless otherwise indicated herein or otherwise clearly contradicted by context. The disclosure is not limited to the described order of the steps. The use of any and all examples, or exemplary language (e.g., “such as”) provided herein, is intended merely to better illuminate the embodiments and does not pose a limitation on the scope of the disclosure unless otherwise claimed. Numerous modifications and adaptations will be readily apparent to one of ordinary skill in the art without departing from the spirit and scope of the disclosure.

It should be understood that embodiments of the disclosure described herein should be considered in a descriptive sense only and not for purposes of limitation. Descriptions of features or aspects within each embodiment should typically be considered as available for other similar features or aspects in other embodiments of the disclosure.

While one or more embodiments have been described with reference to the figures, it will be understood by those of ordinary skill in the art that various changes in form and details may be made therein without departing from the spirit and scope as defined by the following claims.

What is claimed is:

1. An apparatus for driving a liquid crystal lens, the apparatus comprising:
a first substrate and a second substrate which face each other;
an electrode on the first substrate, the electrode comprising a plurality of areas that are spaced apart from each other;
a common ground electrode on the second substrate;
a liquid crystal layer injected between the first substrate and the second substrate and comprising a plurality of liquid crystal molecules;
a voltage source configured to respectively apply separate voltages to the plurality of areas according to a voltage profile after a threshold voltage is applied to the plurality of areas; and
a processor configured to control a voltage applied by the voltage source to the plurality of areas.

2. The apparatus of claim 1, wherein the threshold voltage comprises a voltage that allows the plurality of liquid crystal molecules to have a maximum value of a gradient that is parallel to a direction of an applied electric field.

3. The apparatus of claim 1, wherein the voltage source is further configured to apply an alternating current (AC) threshold voltage to the electrode.

4. The apparatus of claim 1, wherein the voltage source is further configured to apply a direct current (DC) threshold voltage to the electrode.

5. The apparatus of claim 1, wherein the processor is further configured to set a period of time, during which the threshold voltage is applied to the electrode, to be equal to or greater than a reaction time of the plurality of liquid crystal molecules.

6. The apparatus of claim 1, wherein the processor is further configured to determine a voltage of the threshold voltage such that a gradient of the plurality of liquid crystal molecules corresponding to a gap area between the plurality of areas has a value within a preset range.

7. The apparatus of claim 1, wherein the processor is further configured to select the threshold voltage corresponding to the voltage profile of the plurality of liquid crystal molecules from among a plurality of threshold voltages which are stored in advance in a database in association with a plurality of voltage profiles.

8. A method of driving a liquid crystal lens, the method comprising:
obtaining information regarding a threshold voltage and a voltage profile which is used to adjust a refractive index of a liquid crystal layer including a plurality of liquid crystal molecules injected between a first substrate and a second substrate;
applying the threshold voltage to a plurality of areas of the first substrate from among the first substrate, on which an electrode comprising the plurality of areas that are spaced apart from each other is formed, and the second substrate on which a common ground electrode is formed; and
respectively applying separate voltages to the plurality of areas according to the voltage profile.

9. The method of claim 8, wherein the threshold voltage comprises a voltage that allows the plurality of liquid crystal molecules to have a maximum value of a gradient that is parallel to a direction of an applied electric field.

10. The method of claim 8, wherein a voltage source is configured to apply an alternating current (AC) threshold voltage to the electrode.

11. The method of claim 8, wherein a voltage source is configured to apply a direct current (DC) threshold voltage to the electrode.

12. The method of claim 8, further comprising setting a period of time, during which the threshold voltage is applied to the electrode, to be equal to or greater than a reaction time of the plurality of liquid crystal molecules.

13. The method of claim 8, wherein the obtaining comprises determining the threshold voltage such that a gradient of the plurality of liquid crystal molecules corresponding to a gap area between the plurality of areas has a value within a preset range.

14. The method of claim 8, wherein the obtaining comprises selecting a threshold voltage corresponding to a voltage profile of the plurality of liquid crystal molecules from among a plurality of threshold voltages which are stored in advance in a database in association with a plurality of voltage profiles.

15. A non-transitory computer-readable recording medium having recorded thereon a program which, when executed by a computer, performs the method of claim 8.
